(19) United States
(12) Patent Application Publication
(10) Pub. No.: US 2008/0276461 A1
(43) Pub. Date: Nov. 13, 2008

(54) EATING UTENSIL CAPABLE OF AUTOMATIC BITE COUNTING

(76) Inventor: Steven Gold, Tiburon, CA (US)

Correspondence Address: Steven Gold, 50 Mt. Tiburon, Tiburon, CA, 94920, US

(21) Appl. No.: 12/035,355

(22) Filed: Feb. 21, 2008

Related U.S. Application Data
(60) Provisional application No. 60/928,105, filed on May 8, 2007.

(51) Int. Cl. B25F 1/00; A47J 43/28

(52) U.S. Cl. 30/142; 30/322; 30/324

(57) ABSTRACT

An eating utensil includes a food carrier configured to convey food to a mouth, a sensor configured to sense the weight of food carried on the food carrier, a handle attached to the food carrier and configured to be engaged by a hand of an eater, an electric circuit in communication with the sensor and configured to count a bite of food in response to the weight of food carried on the food carrier, and a display device configured to display a number of bites consumed by the eater.

The present patent application claims priority to U.S. provisional patent application 60/928,105, titled “Eating utensil—monitors the number of bites of food consumed and regulates the time between bites”, filed May 8, 2007, the content of which is incorporated herein by reference.

### BACKGROUND

The present disclosure relates to an improved eating utensil that can help an eater pace and monitor the amount of food consumed using the eating utensil.

Devices for modifying eating behavior have previously been reported. For example, U.S. Pat. No. 5,421,089 to Dubas, et al. (1995) discloses eating utensils with a timing circuit that can emit signals at pre-programmed timing to advise an eater the time for taking each bite. The timing of the signals is predetermined and independent of the eater's eating pattern. The emitted signals act as a counter and are not linked to the previous bite. The device is often not useful because the eater can eat slower or faster than the counter set by the signals.

U.S. Pat. No. 6,558,165 to Curry, et al. discloses a behavior modification device that fits within a closed hand, and can be programmed to produce signals for eating improvement. The signals are emitted at various predetermined settings irrespective eater's behavior. The counter is unrelated to the actions by the eater.

U.S. Pat. No. 5,299,356 to Maxwell, III discloses an eating utensil for counting the number of bites the eater consumes in accordance with a specific diet plan regulating the fat intake by the eater. The eater is required to push a button to activate the counter after each bite. Bites are not counted if the eater forgets to push the button.

A drawback of the aforementioned eating devices is that they can provide inaccurate signals to an eater when his bites fall out of synchronization with the eating device. Another drawback of some of the conventional eating devices is that they require eater's active handling to operate.

### SUMMARY

In one general aspect, the present invention relates to an eating utensil that includes a food carrier configured to convey food to a mouth, a sensor configured to sense the weight of food carried on the food carrier, a handle attached to the food carrier and configured to be engaged by a hand of an eater, an electric circuit in communication with the sensor and configured to count a bite of food in response to the weight of food carried on the food carrier, and a display device configured to display a number of bites consumed by the eater.

In another general aspect, the present invention relates to an eating utensil comprising: a food carrier configured to convey food to a mouth; a sensor configured to sense the weight of food carried on the food carrier; a handle attached to the food carrier and configured to be engaged by a hand of an eater; an electric circuit in communication with the sensor, wherein the electric circuit is configured to count a bite of food in response to the weight of food carried on the food carrier and to compute time elapsed from a previous bite; and a display device configured to display the count of bites consumed by the eater and the time elapsed from a previous bite.

In another general aspect, the present invention relates to a method for taking bites of food using an eating utensil. He method includes conveying food to a mouth of an eater by a food carrier attached to a handle held by a hand of the eater; automatically sensing the weight of food carried on the food carrier by a sensor; automatically counting a bite of food by an electric circuit in response to the weight of food carried on the food carrier; and automatically displaying on a display device a number of bites consumed by the eater.

Implementations of the system may include one or more of the following features. The electric circuit can include a timer configured to measure time elapsed from a previous bite of food using the food carrier by the eater. The electric circuit can compute time elapsed from a previous bite, and wherein the display device is configured to display the time elapsed from a previous bite. The electric circuit can produce a suggested time for a next bite after the previous bite. The display device can display the suggested time for a next bite after the previous bite. The eating utensil can further include means for emitting a light, sound, or vibration signal to indicate the suggested time for a next bite after the previous bite. The sensor can sense a pressure produced by the weight of food carried on the food carrier. The food carrier can be a spoon or a fork. The display device can be housed inside the handle. At least a portion of the handle is transparent to allow the display device to be visible by the eater. The electric circuit can be housed inside the handle.

Various implementations of the methods and devices described herein may include one or more of the following advantages. The described eating utensil can help an eater to improve eating behavior by providing more accurate measurement and feedback to an eater than conventional devices. The eating utensil can automatically count and display the number of bites in accordance to the specific eating pattern of the eater. The eating utensil can also display the time elapsed and suggested time for the next bite. The bite measurement and counting are automatic and do not require an eater's manual operation, and are thus more accurate and not affected by human errors.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles, devices and methods described herein.

FIGS. 1A-1C are respectively top, side, and bottom views of an eating utensil in accordance with the present invention.

FIG. 1D is an end view of the eating utensil of FIGS. 1A-1C.

FIG. 1E is another end view of the eating utensil of FIGS. 1A-1C.

FIG. 2 is a perspective view of the eating utensil of FIGS. 1A-1C.

FIGS. 3A-3C are exploded perspective views respectively illustrating portions of the eating utensil of FIGS. 1A-1C.

FIG. 4 is a flowchart for using the eating utensil of FIGS. 1A-1C.

### DETAILED DESCRIPTION

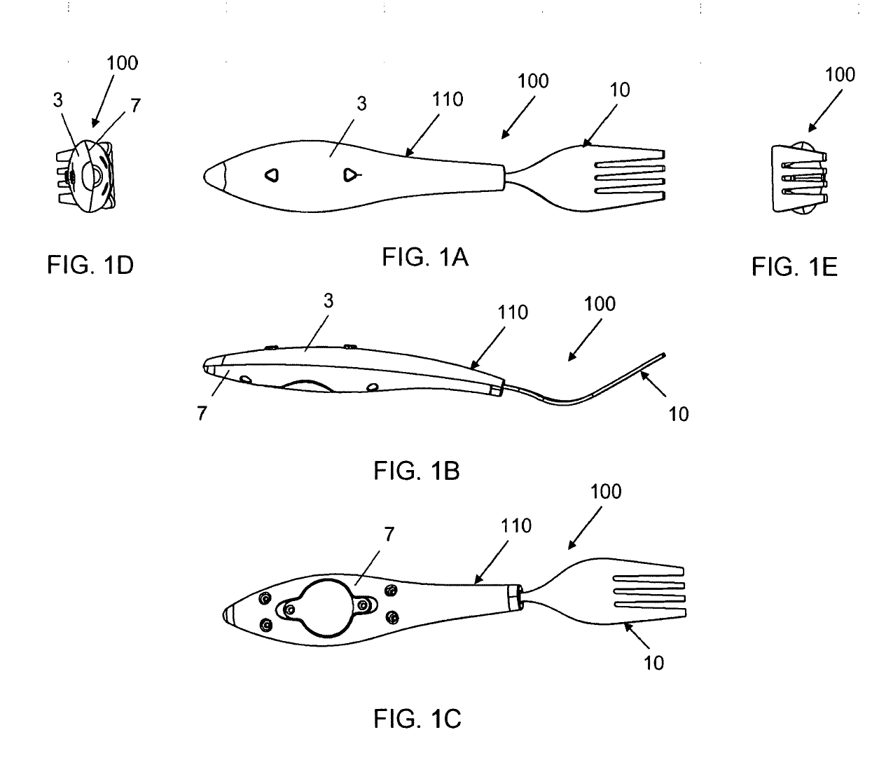

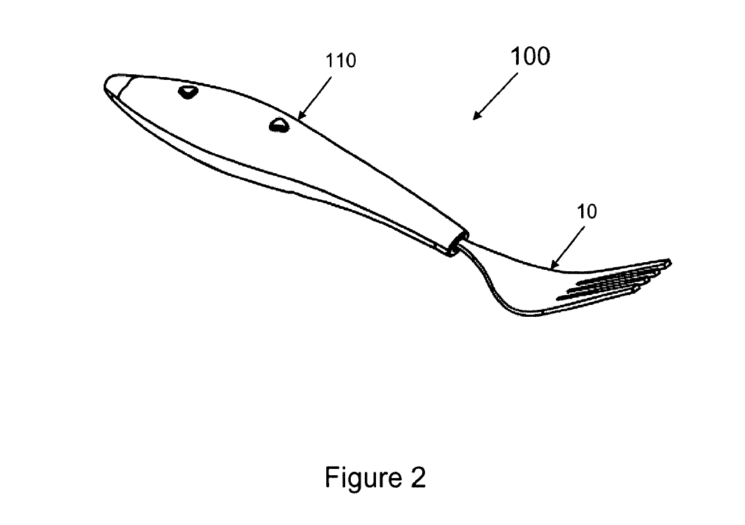

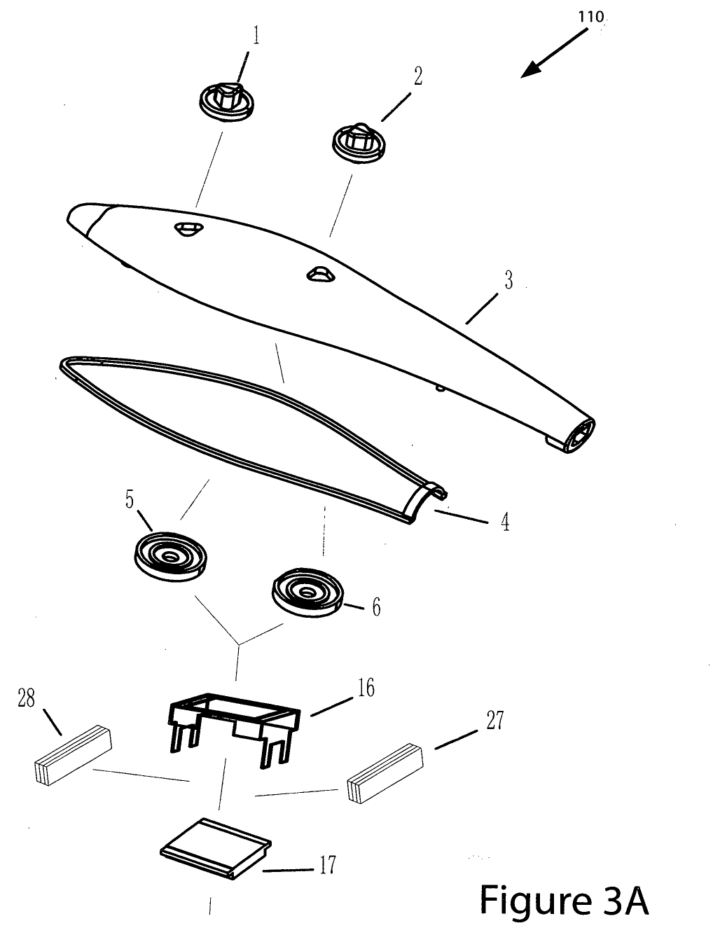

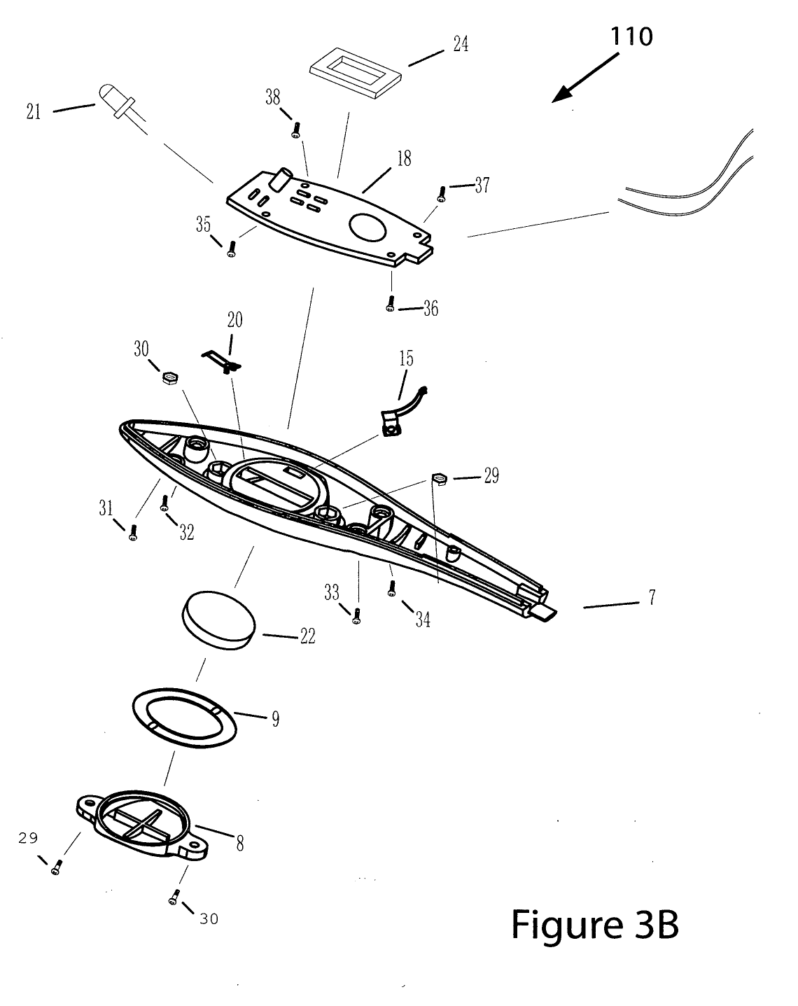

To overcome the above described disadvantages in the conventional eating utensils, the present invention describes an eating utensil that can count the number of bites of food that an eater consumes and can prompt a user to consume another bite after a period of time subsequent to the previous bite. Referring to FIGS. 1A-1E and 2, an eating utensil 100 includes a handle 110 and a food carrier 10. The food carrier 10 can for example be a fork, a spoon, etc. The handle 110 includes a top handle portion 3 and a lower handle portion 7.

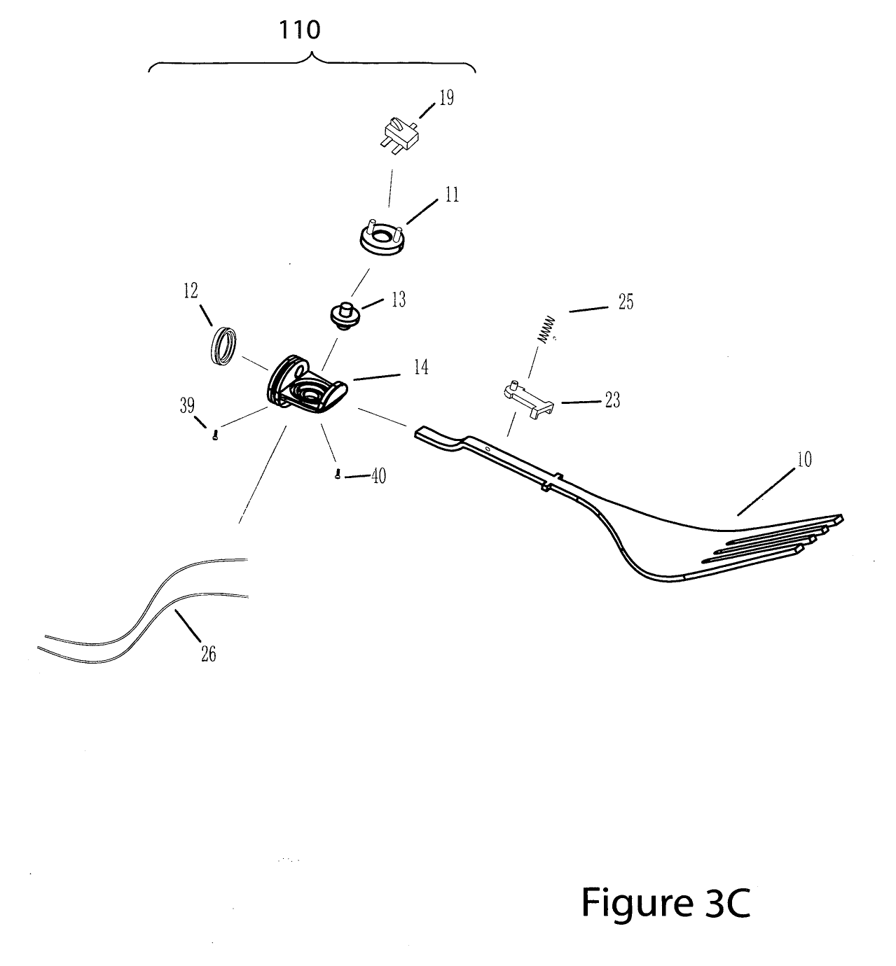

Referring to FIGS. 3A-3C, the eating utensil 100 includes a top handle portion 3 and a lower handle portion 7, a circuit board 18, a liquid crystal display (LCD) 17, and a main housing O-ring 4 mounted to the bottom of the lower handle portion 7 and pressed against the top handle portion 3 when the handle 110 is enclosed. The circuit board 18 is held by screws 37 and 38 to the top handle portion 3. The top handle portion 3 is made of a transparent material such as a clear plastic to allow the information displayed on the LCD 17 to be seen from outside. The top handle portion 3 is mounted to the lower handle portion 7 by screws 31-34. Buttons 1, 2 are held in place on the top handle portion 3 by waterproof gaskets 5 and 6. The LCD 17 is held in place by LCD holders 16, 24 and supports 27, 28.

The food carrier 10 is held in place in the top handle portion 3 and the lower handle portion 7 by notches in the handle 10 and the lower handle portion 7. The food carrier 10 pivots on the front of the top handle portion 3 and the lower handle portion 7 so that weight on the food carrier 10 causes the other end of the food carrier 10 to push up against a trigger button 13. The trigger button 13 is held in place by a trigger button housing 14, trigger button cover 11 and O-ring 12, which are held together by screws 39 and 40. Wires 26 connect the tact-switch 19 to the circuit board 18. The handle 110 can also include a small scale that can weigh the amount of food consumed in each bite and keeps a count of the bites consumed by the eater.

The weight of food carried by the end of the food carrier 10 can cause the trigger button 13 to push against the tact-switch 19, which activates the counter and timer on the circuit board 18. The bite is counted automatically when there is pressure on the food carrier 10 and does not require additional action by the eater (such as pressing a button after each bite). The bite counter is accurate and will not miss counts when an eater forgets to push button in a conventional eating utensil. A spring 25 is held in place by sensor spring holder 23 between the tact-switch 19 and the end of the food carrier 10, preventing the food carrier 10 from pressing the sensor except when there is weight on the food carrier 10.

The eating utensil 100 is powered by a battery 22, which is held in place on the lower handle portion 7 by screws 29, 30 attached to battery door 8 and battery O-ring 9.

The battery 22 can be replaceable and rechargeable. The battery 22 provides power to the circuit board 18 via battery contact plates 15 and 20 that can be soldered on the circuit board 18 and the contact battery 22.

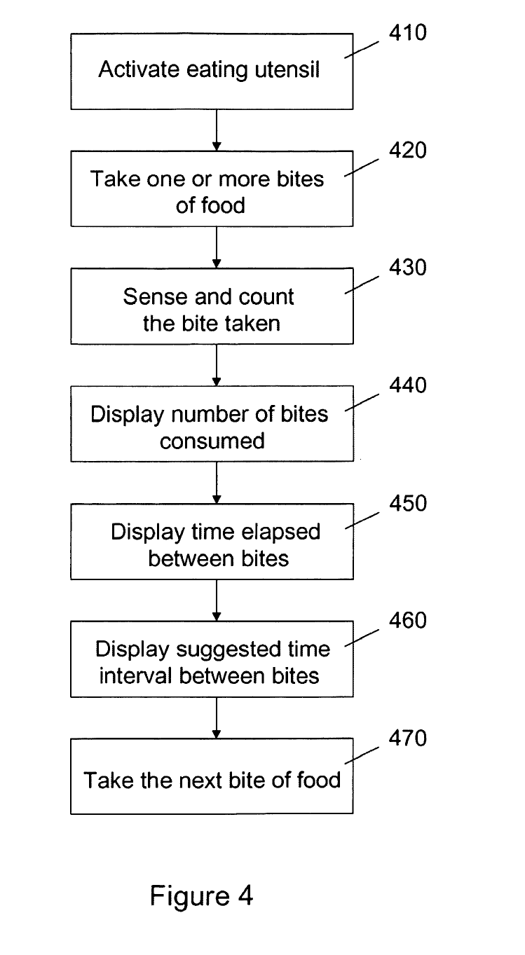

Referring to FIG. 4, an exemplified process of using the eating utensil 100 is described as follows. The eater presses the buttons I—against a contact sensor on the circuit board 18 to activate the eating utensil by (step 410). This activates the timer and the counter on the circuit board 18, a display, and a pressure sensor for the food carrier. The eater starts to take one or more bites of food using the eating utensil 100 (step 420). A pressure sensor in the eating utensil can sense the bite and add it to the bite count (step 430). The number of bites consumed is displayed in LCD 17 (step 440). The circuit board 18 can also control the LCD 17 to display the time that has elapsed from the last bite and the suggested time interval between bites (step 450). The LCD 17 can also display suggested time interval between bites (step 460). The eater can take the next bite of food according to the suggested time interval between bites (step 470). The counter can be reset by the eater by pressing the buttons 1, 2 against the contact sensors on the circuit board 18.

It is understood that the disclosed systems and methods are compatible with other eating utensils such as spoons, sporks, etc. The components, configurations of the components, and the materials may vary without deviating from the spirit of the present invention. The display device on the eating utensil can be a light emitting diode (LED) display information displayed can be conveyed by blinking of LEDs. The suggested time for the next bite for the eater can be indicated by displayed information on a display device, by a light signal such as a blinking light emitting diode (LED), sound, or vibration.

What is claimed is:

1. An eating utensil, comprising:
a food carrier configured to convey food to a mouth;
a sensor configured to sense the weight of food carried on the food carrier;
a handle attached to the food carrier and configured to be engaged by a hand of an eater;
an electric circuit in communication with the sensor and configured to count a bite of food in response to the weight of food carried on the food carrier; and
a display device configured to display a number of bites consumed by the eater.

2. The eating utensil of claim 1, wherein the electric circuit includes a timer configured to measure time elapsed from a previous bite of food using the food carrier by the eater.

3. The eating utensil of claim 1, wherein the electric circuit is configured to compute time elapsed from a previous bite, and wherein the display device is configured to display the time elapsed from a previous bite.

4. The eating utensil of claim 1, wherein the electric circuit is configured to produce a suggested time for a next bite after the previous bite

5. The eating utensil of claim 4, wherein the display device is configured to display the suggested time for a next bite after the previous bite.

6. The eating utensil of claim 4, further comprising means for emitting a light, sound, or vibration signal to indicate the suggested time for a next bite after the previous bite.

7. The eating utensil of claim 1, wherein the sensor is configured to sense a pressure produced by the weight of food carried on the food carrier.

8. The eating utensil of claim 1, wherein the food carrier is a spoon or a fork.

9. The eating utensil of claim 1, wherein the display device is housed inside the handle, and wherein at least a portion of the handle is transparent to allow the display device to be visible by the eater.

10. The eating utensil of claim 1, wherein the electric circuit is housed inside the handle.

11. An eating utensil, comprising:
a food carrier configured to convey food to a mouth;
a sensor configured to sense the weight of food carried on the food cannier;
a handle attached to the food carrier and configured to be engaged by a hand of an eater;
an electric circuit in communication with the sensor, wherein the electric circuit is configured to count a bite of food in response to the weight of food carried on the food carrier and to compute time elapsed from a previous bite; and
a display device configured to display the count of bites consumed by the eater and the time elapsed from a previous bite.

12. The eating utensil of claim 11, wherein the electric circuit is configured to produce a suggested time for a next bite after the previous bite, and wherein the electric circuit is configured to display the suggested time for a next bite after the previous bite.

13. The eating utensil of claim 11, wherein the sensor is configured to sense a pressure produced by the weight of food carried on the food carrier.

14. The eating utensil of claim 11 wherein the food carrier is a spoon or a fork.

15. A method for taking bites of food using an eating utensil, comprising:
conveying food to a mouth of an eater by a food carrier attached to a handle held by a hand of the eater;
automatically sensing the weight of food carried on the food carrier by a sensor;
automatically counting a bite of food by an electric circuit in response to the weight of food carried on the food carrier; and
automatically displaying on a display device a number of bites consumed by the eater.

16. The method of claim 14, further comprising measuring time elapsed from a previous bite of food by the eater.

17. The method of claim 16, further comprising displaying the time elapsed from the previous bite by the display device.

18. The method of claim 14, further comprising:
producing a suggested time for a next bite after the previous bite by the electric circuit, and
indicating a suggested time for a next bite by the display device after a previous bite.

19. The method of claim 18, wherein the step of indicating comprises emitting a light, sound, or vibration signal to indicate the suggested time for a next bite after the previous bite.

20. The method of claim 14, wherein the food carrier is a spoon or a fork.
